(19) United States
(12) Patent Application Publication
(10) Pub. No.: US 2026/0128812 A1
(43) Pub. Date: May 7, 2026

(54) SUPPORT FOR DATA-AIDED COMMUNICATIONS

(71) Applicant: Samsung Electronics Co., Ltd., Suwon-si (KR)

(72) Inventors: Caleb K. Lo, San Jose, CA (US); Joonyoung Cho, Portland, OR (US); Jianzhong Zhang, Dallas, TX (US); Fabrizio Carpi, Dallas, TX (US)

(21) Appl. No.: 19/319,665

(22) Filed: Sep. 4, 2025

Related U.S. Application Data
(60) Provisional application No. 63/716,495, filed on Nov. 5, 2024.

(51) Int. Cl. H04L 1/00; H04L 27/36

(52) U.S. Cl. CPC H04L 1/0003; H04L 1/0009; H04L 27/36

(57) ABSTRACT

A user equipment (UE) includes a transceiver configured to: transmit, to a base station (BS), UE capability information that indicates support for data-aided modulation constellations, wherein the data-aided modulation constellations support a first transmission mode utilizing data symbols for channel estimation, and receive, from the BS, a modulation and coding scheme (MCS) indication. The UE also includes a processor operably coupled to the transceiver and configured to: determine, based on the MCS indication, a first data-aided modulation constellation, and generate first modulation symbols from input bits according to the first determined data-aided modulation constellation. The transceiver is further configured to transmit, to the BS, the first modulation symbols.

### CROSS-REFERENCE TO RELATED APPLICATION AND CLAIM OF PRIORITY

The present application claims priority under 35 U.S.C. § 119(e) to U.S. Provisional Patent Application No. 63/716,495 filed on Nov. 5, 2024, which is hereby incorporated by reference in its entirety.

### TECHNICAL FIELD

This disclosure relates generally to wireless networks. More specifically, this disclosure relates to a method and apparatus for data-aided communications.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for data-aided communications in wireless communication systems.

In one embodiment, a user equipment (UE) is provided. The UE includes a transceiver configured to: transmit, to a base station (BS), UE capability information that indicates support for data-aided modulation constellations, wherein the data-aided modulation constellations support a first transmission mode utilizing data symbols for channel estimation, and receive, from the BS, a modulation and coding scheme (MCS) indication. The UE also includes a processor operably coupled to the transceiver and configured to: determine, based on the MCS indication, a first data-aided modulation constellation, and generate first modulation symbols from input bits according to the first determined data-aided modulation constellation. The transceiver is further configured to transmit, to the BS, the first modulation symbols.

In another embodiment, a BS is provided. The BS includes a transceiver configured to: receive, from a UE, UE capability information that indicates support for data-aided modulation constellations, wherein the data-aided modulation constellations support a first transmission mode utilizing data symbols for channel estimation; transmit, to the UE an MCS indication; and receive, from the UE, first modulation symbols generated from input bits according to a first data-aided modulation constellation determined based on the MCS indication.

In yet another embodiment, a method performed by a UE is provided. The method includes transmitting, to a BS, UE capability information that indicates support for data-aided modulation constellations, where the data-aided modulation constellations support a first transmission mode utilizing data symbols for channel estimation. The method also includes receiving, from the BS, an MCS indication, determining, based on the MCS indication, a first data-aided modulation constellation, generating first modulation symbols from input bits according to the first determined data-aided modulation constellation; and transmitting, to the BS, the first modulation symbols.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network in accordance with example embodiments of the present disclosure;

FIG. 2 illustrates an example gNB in accordance with example embodiments of the present disclosure;

FIG. 3 illustrates an example UE in accordance with example embodiments of the present disclosure;

FIG. 4 illustrates an example network device in accordance with example embodiments of the present disclosure;

FIG. 5 illustrates an example RS pattern in accordance with example embodiments of the present disclosure;

FIG. 6 illustrates example modulation constellations that can be used to facilitate the RS overhead reduction in accordance with example embodiments of the present disclosure;

FIG. 7 illustrates an example data-aided wireless communication system in accordance with example embodiments of the present disclosure;

FIG. 8 illustrates an example reduced RS overhead in accordance with example embodiments of the present disclosure;

FIG. 9 illustrates an example flow diagram of a data-aided transmission method in accordance with example embodiments of the present disclosure;

FIG. 10 illustrates an example flow diagram of a data-aided transmission method in accordance with example embodiments of the present disclosure;

FIG. 11 illustrates example modulation constellations that can be configured for data-aided transmission in accordance with example embodiments of the present disclosure;

FIG. 12 illustrates example DMRS patterns that can be configured for data-aided transmission in accordance with example embodiments of the present disclosure;

FIG. 13 illustrates an example data-aided transmission method for operations at a UE to support BS determination of an MCS indication for data-aided transmission in accordance with example embodiments of the present disclosure;

FIG. 14 illustrates an example data-aided transmission method for operations at a BS to support BS determination of an MCS indication for data-aided transmission in accordance with example embodiments of the present disclosure;

FIG. 15 illustrates an example data-aided transmission method for operations at a UE to support BS configuration of an MCS indication for data-aided transmission in accordance with example embodiments of the present disclosure;

FIG. 16 illustrates an example data-aided transmission method for operations at a BS to support BS configuration of an MCS indication for data-aided transmission in accordance with example embodiments of the present disclosure;

FIG. 17 illustrates an example method for operations at a UE to support UE-initiated fallback to a pilot-aided transmission method in accordance with example embodiments of the present disclosure;

FIG. 18 illustrates an example method for operations at a BS to support UE-initiated fallback to a pilot-aided transmission method in accordance with example embodiments of the present disclosure;

FIG. 19 illustrates an example method for operations at a UE to support BS-initiated fallback to a pilot-aided transmission method in accordance with example embodiments of the present disclosure;

FIG. 20 illustrates an example method for operations at a BS to support BS-initiated fallback to a pilot-aided transmission method in accordance with example embodiments of the present disclosure;

FIG. 21 illustrates an example method for operations at a UE to support UE-side ML-based data-aided transmission method selection in accordance with example embodiments of the present disclosure;

FIG. 22 illustrates an example method for operations at a BS to support a UE-side ML-based data-aided transmission method selection in accordance with example embodiments of the present disclosure;

FIG. 23 illustrates an example method for operations at a UE to support a UE-initiated fallback to the pilot-aided transmission method in accordance with example embodiments of the present disclosure;

FIG. 24 illustrates an example method for operations at a BS to support UE-initiated fallback to a pilot-aided transmission method in accordance with example embodiments of the present disclosure;

FIG. 25 illustrates an example method for operations at a UE to support a BS-initiated fallback to the pilot-aided transmission method in accordance with example embodiments of the present disclosure;

FIG. 26 illustrates an example method for operations at a BS to support a BS-initiated fallback to the pilot-aided transmission method in accordance with example embodiments of the present disclosure;

FIG. 27A-27B illustrate example MAC CEs in accordance with example embodiments of the present disclosure; and

FIG. 28 illustrates an example flow chart for a data-aided communications method in accordance with example embodiments of the present disclosure.

### DETAILED DESCRIPTION

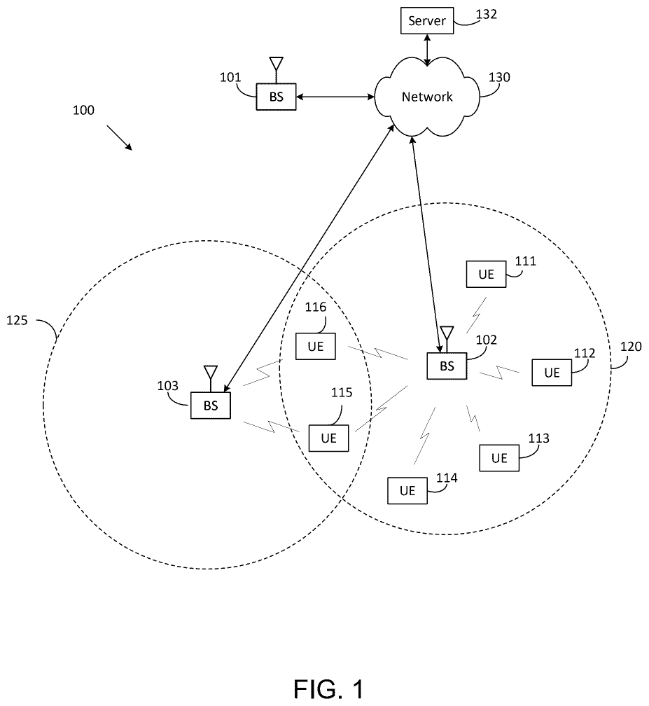

FIGS. 1 through 28, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated there with, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an artificial intelligence (AI)-based wireless communication system. As such, the at least one network 130 may be operably coupled to an electronic device (e.g., without limitation, a network server) 132 configured to, for example and without limitation, receive data from the gNBs 101-103 and train an AI and/or ML model (hereinafter, also referred to as the AI model) to support data-aided transmissions. The server 132 may represent one or more servers, and each server 132 includes a suitable computing or processing device for training the AI model. Each server 132 could, for example, include one or more processing devices, one or more memories storing instructions and data, and one or more network interfaces to receive the data. The AI model is then trained and deployed to effectively to support data-aided transmissions in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support data-aided transmissions in wireless communication systems. In certain embodiments, one or more of the gNBs 101-103 include circuitry, programing, or a combination thereof, to support data-aided transmissions in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

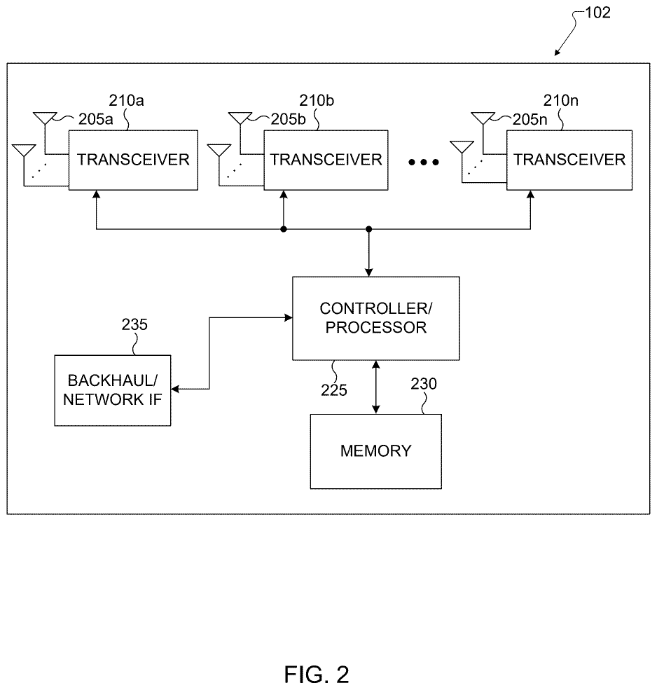

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support data-aided transmissions in wireless communication systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

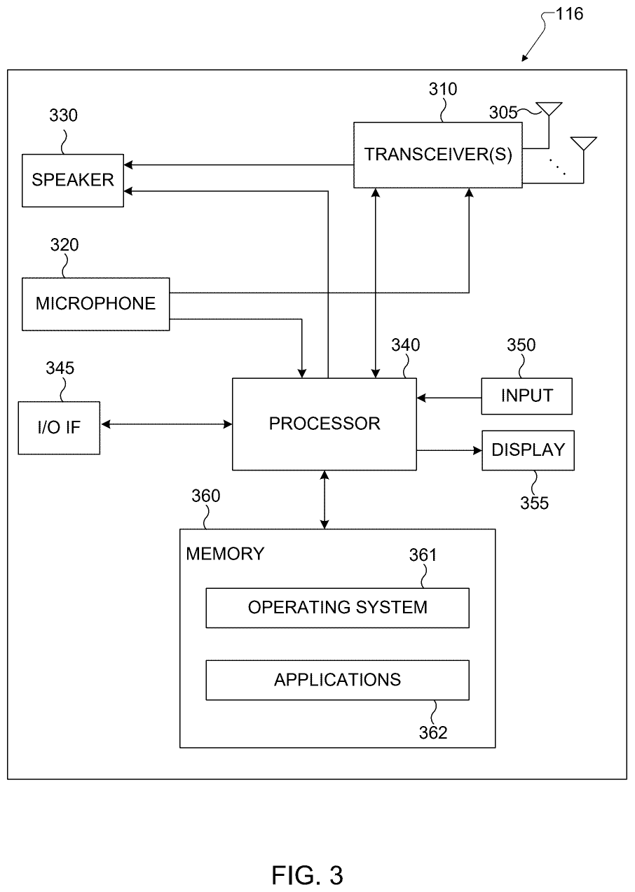

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support data-aided transmissions in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

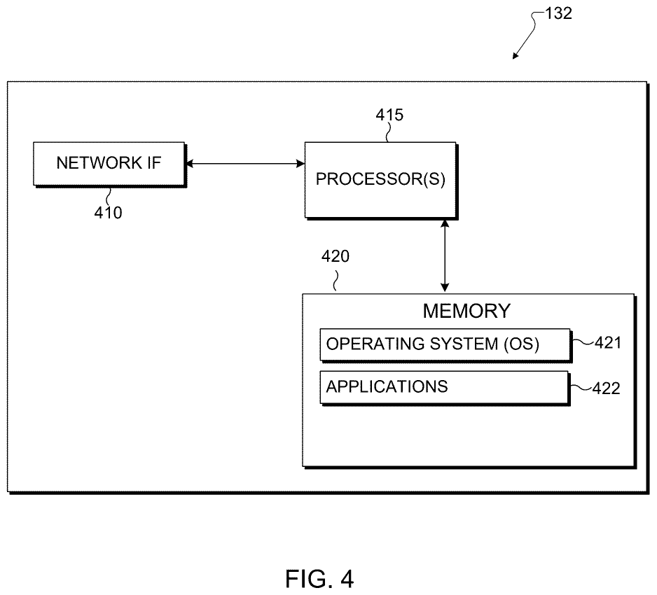

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410 and the UEs 111-116 via the gNBs 101-103.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network as well as a CPU, a GPU or a tensor processing unit (TPU) that provides significant computational resources required for training the neural network.

The processor 415 is also capable of executing other processes and programs resident in the memory 420, such as operations that receive and store data. As described in greater detail below, the processor 415 may execute processes to train an AI model to support data-aided transmissions in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for an AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include data prepared for training of the AI model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

The modern wireless systems, such as those described regarding FIGS. 1-4, utilize several types of reference signals (RSs) that have been defined. For example, a channel state information reference signal (CSI-RS) may be used for DL communication between a gNB and a UE, where the UE uses received CSI-RS to measure DL CSI and report those measurements to the gNB. Also, a demodulation reference signal (DMRS) may be used by a receiver (either for DL or UL communications) to estimate CSI to demodulate received data.

A time-frequency mapping function may be applied to RSs such as the CSI-RS and DMRS before they are transmitted, yielding a particular RS pattern. An RS pattern may depend on parameters such as a transmit antenna port, code division multiplexing (CDM) type, and frequency hopping enablement status.

When a resource element (RE) is used to transmit an RS, the transmission overhead may increase as that RE is not used to transmit data. It may be advantageous to reduce—or even eliminate—the overhead of the RS based on the statistics of an underlying randomly-varying wireless channel. For example, if the channel is static, then an RS signaling can be (at least temporarily) disabled, assuming that a properly-designed receiver can still recover transmitted data in the absence of an RS.

5G NR supports flexibility in the selection of an RS pattern. The selection of an RS pattern may be based on the statistics of the underlying randomly-varying wireless channel. For example, the parameter dmrs-AdditionalPosition can be used to increase the number of DMRS in a given slot in high-mobility scenarios. As another example, the parameters periodicityAndOffset-p and periodicityAndOffset-sp can be used to vary the periodicity (and slot offset) of SRS. The details of the algorithm for selecting an RS pattern are typically left to the network.

The present disclosure describes a framework for supporting AI/ML techniques for reducing the overhead of the RS via a data-aided transmission, in which data symbols may be leveraged for the CSI estimation and data demodulation, based on the statistics of the underlying wireless channel. Methods for reducing the signaling overhead of RS via data-aided transmission, including information elements to be exchanged between a transmitter and a receiver and the corresponding signaling detail, are provided in this disclosure below.

The following documents and standards descriptions are hereby incorporated by reference into the present disclosure as if fully set forth herein:
[1] 3GPP, TS 38.211, 5G; NR; Physical channels and modulation
[2] 3GPP, TS 38.331, 5G; NR; Radio Resource Control (RRC); Protocol specification
[3] 3GPP, TS 38.321, 5G; NR; Medium Access Control (MAC); Protocol specification.

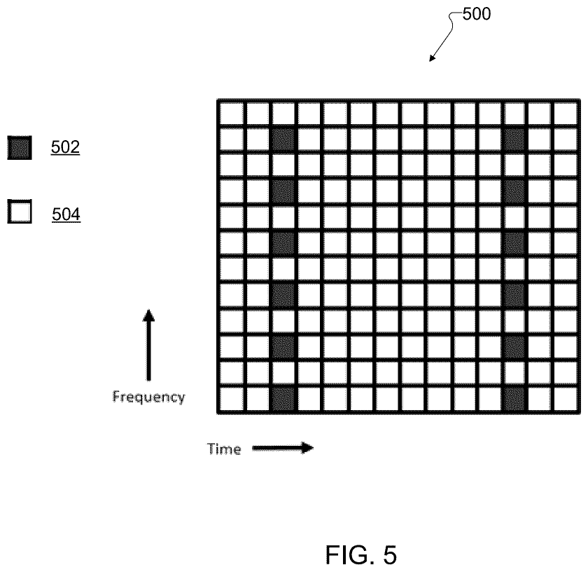

FIG. 5 illustrates an example RS pattern 500 in accordance with example embodiments of the present disclosure. The example RS pattern 500 shown in FIG. 5 is for illustration only, and the RS pattern could have the same or similar configuration. However, FIG. 5 does not limit the scope of this disclosure to any particular RS pattern.

In the example RS pattern 500 as shown in in FIG. 5, an RS is placed in the first REs 502 while data is placed in the second REs 504. In this example, 12 out of the 168 REs in this physical resource block (PRB) contain the RS, and thus, the overhead of the RS is about 7%. Tracking of channel variations over time may be facilitated by placing the RS on the third and the twelfth symbols. Also, tracking of channel variations over frequency may be facilitated by placing the RS on every other RE in those two symbols.

The RS overhead of about 7% in FIG. 5 can be reduced in some situations as illustrated in FIGS. 8 and 12.

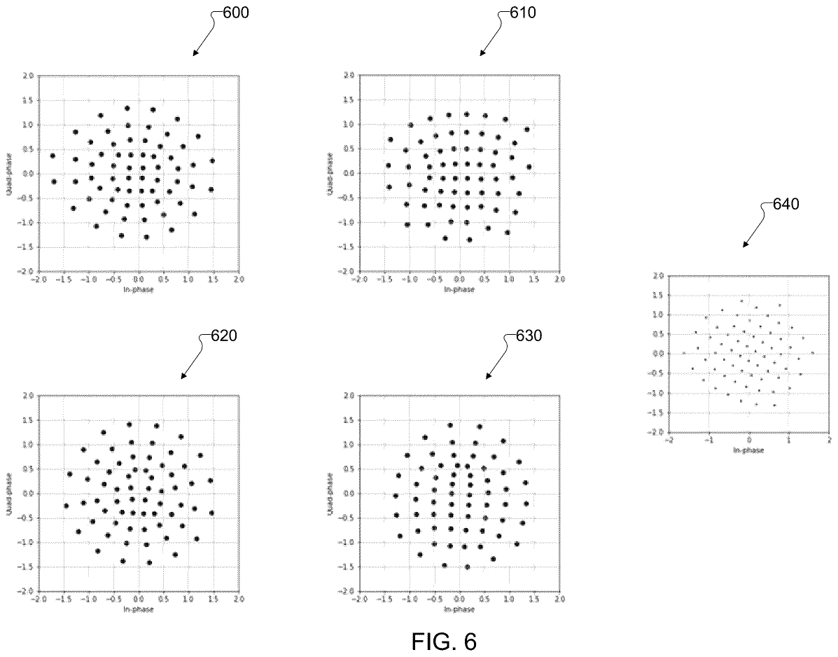

FIG. 6 illustrates example modulation constellations 600, 610, 620, 630, 640 that can be used to facilitate the RS overhead reduction in accordance with example embodiments of the present disclosure. Each of these modulation constellations 600, 610, 620, 630, 640 has been obtained via an AI/ML framework. The example modulation constellations 600, 610, 620, 630, 640 shown in FIG. 6 are for illustration only, and the modulation constellations 600, 610, 620, 630, 640 could have the same or similar configuration. However, FIG. 6 does not limit the scope of this disclosure to any particular modulation constellations.

The example constellations 600, 610, 620, 630, 640 may be more irregular than other modulation constellations such as 64-QAM, thereby increasing their robustness to amplitude and phase impairments. For example, rotating any of these constellations 600, 610, 620, 630, 640 through an arbitrary angle may yield a different constellation, i.e., they have no inherent phase ambiguity. In contrast, rotating a square QAM constellation through 90 degrees yields an identical constellation. Thus, data symbols from the constellations 600, 610, 620, 630, 640 can be used for channel estimation and demodulation. Whereas, if RSs are not transmitted and if the channel applies a phase rotation of 90 degrees, data symbols from a square QAM constellation may not be demodulated.

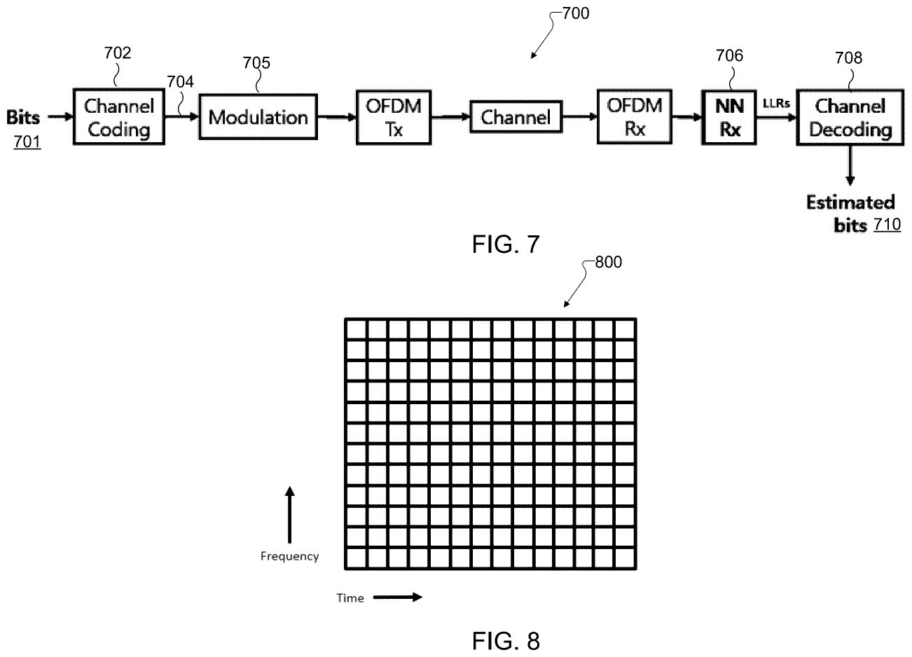

Along with the asymmetric modulation constellations, data-aided transmissions may rely on an AI/ML receiver as illustrated in FIG. 7.

FIG. 7 illustrates an example wireless communication system 700 supporting data-aided transmission in accordance with example embodiments of the present disclosure. The example wireless communication system 700 as shown in FIG. 7 is for illustration only, and the wireless communication system 700 could have the same or similar configuration. However, FIG. 7 does not limit the scope of this disclosure to any particular embodiment of wireless communication system.

The example wireless communication system 700 supporting data-aided transmission may receive bits 701 to be encoded by a channel encoder 702. The encoded bits 704 may then be input to a modulator 705 for modulation using a constellation such as one of the example constellations 600, 610, 620, 630, 640 in FIG. 6. That is, the channel coding block (i.e., the channel encoder 702) may take uncoded bits and turn them into coded bits, which may then be modulated to constellation symbols by the modulation block (i.e., the modulator 705).

The system 700 may also use an AI/ML receiver 706 to minimize an error between the bits 710 from a channel decoder 708 and the bits 701 input to a channel encoder 702. The AI/ML receiver 706 may be, e.g., a neural network (NN) receiver and output LLRs (log-likelihood ratios), which in turn may be input to the channel decoder 708 to estimate the transmitted bits.

Thus, the data-aided transmission can be enabled by a combination of an asymmetric modulation constellation 600, 610, 620, 630, 640 and an AI/ML receiver 706, resulting in a reduced RS overhead as illustrated in FIGS. 8 and 12.

In one example, a block error rate (BLER) performance of an NN receiver was obtained for data-aided transmission over a 3GPP TDL-A channel model with a root mean square (RMS) delay spread of 30 ns and a Doppler shift of 10 Hz. In that case, no RSs were used for data-aided transmission. The resulting performance loss compared to another receiver with a perfect CSI (e.g., 64-QAM, 1 DMRS with perfect channel estimation) has been shown to be approximately 1 dB. Also, the NN receiver was shown to outperform another receiver with an imperfect CSI (e.g., 64-QAM, 1 DMRS with real channel estimation, corresponding to a practical scenario) by about 0.5 dB. These results may demonstrate the feasibility of data-aided transmission (in example embodiments of the present disclosure) with little or no RS overhead.

FIG. 8 illustrates an example reduced RS overhead 800 in accordance with example embodiments of the present disclosure. The example reduced RS overhead 800 shown in FIG. 8 is for illustration only, and different reduced RS overheads may be achieved using data-aided transmission.

The example reduced RS overhead 800 may be obtained using the wireless communication system 700 of FIG. 7, which utilizes data-aided transmissions.

As shown in FIG. 8, all of the REs in a PRB contain data symbols. Thus, the data-aided communication system 700 as shown in FIG. 7 may not only reduce, but also effectively eliminate the RS overhead.

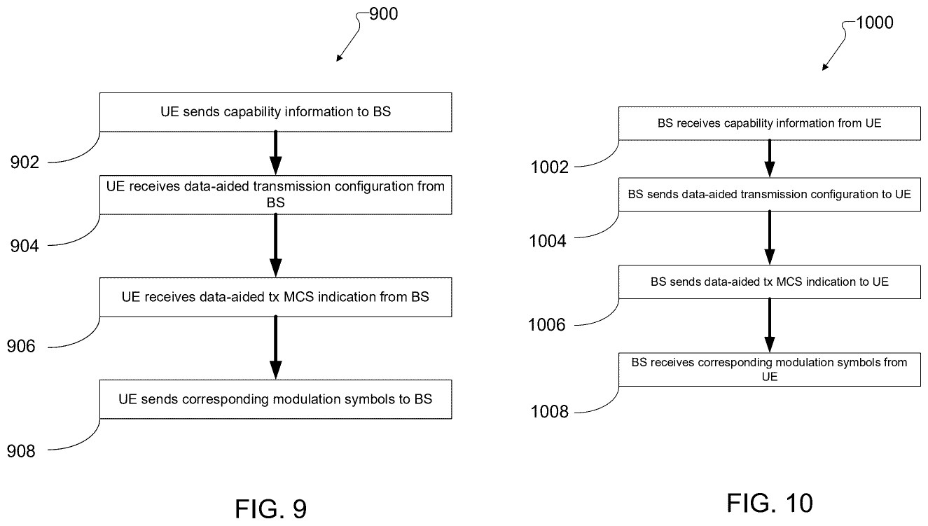

FIG. 9 illustrates an example flow diagram of a data-aided transmission method 900 in accordance with example embodiments of the present disclosure. The data-aided transmission method 900 shown in FIG. 9 may be performed by a UE (e.g., UE 111-116 of FIGS. 1 and 3). The embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of data-aided transmission could be used without departing from the scope of this disclosure.

As shown in the example of FIG. 9, the method 900 begins at step 902. At step 902, a UE may send its capability information to a BS (e.g., gNB 101-103 of FIGS. 1 and 2), including the support of data-aided transmission. Table 1 shows an example of modifying the ModulationOrder IE to indicate all of the transmission methods that a UE can support. In this example, NumModMethods may correspond to the total number of transmission methods, and the “1” values in this bit string may correspond to the modulation methods that this UE can support. Table 1 also shows an example of defining a new DataAidedTxModulationOrder IE, which is a list of identifications (IDs) corresponding to data-aided transmission methods.

TABLE 1
An Example IE ModulationOrder Modification

```
  ModulationOrder : := BIT STRING {SIZE (NumModMethods)}
DataAidedTxModulationOrder : := ENUMERATED
    {16ary_16dB_const1, 64ary_20dB_const3,
    256ary_24dB_const5}
```

At step 904, the UE may receive a data-aided transmission configuration information from the BS. The data-aided transmission configuration information may include information such as enabling/disabling of the mapping between an MCS index and a data-aided transmission method (e.g., information for corresponding modulation constellations).

At step 906, the UE may receive an MCS indication message from the BS for a data-aided transmission method. The BS can use a regular (i.e., currently extant) DCI format for this MCS indication message. It may also define a new DCI format for this MCS indication message. In one example, the UE may use this MCS indication message to determine an MCS index. In another example, the UE may autonomously determine an MCS index.

In one embodiment, a UE can use an MCS index to determine a modulation method for data-aided transmission. Table 2 shows an example of modifying a lookup table (LUT) to facilitate this approach. In this example, each MCS index may map to a modulation order, a target code rate, and an ID of a modulation constellation. This modulation constellation may include a set of points (e.g. 64 points if the modulation order is 6). A UE can use the target code rate for encoding information bits, and the encoded bits can be modulated according to the points in the modulation constellation.

TABLE 2
An Example Modified Lookup Table

| | Modulation | Target Code Rate | |
|---|---|---|---|
| MCS | Order | R × [1024] | Constellation ID |
| . . . | . . . | . . . | . . . |
| Index 10 | 6 | 450 | 64ary_16 dB_const_1 |
| . . . | . . . | . . . | . . . |
| Index 13 | 7 | 512 | 128ary_20 dB_const_3 |
| . . . | . . . | . . . | . . . |
| Index 16 | 8 | 675 | 256ary_24 dB_const_5 |
| . . . | . . . | . . . | . . . |

At step 908, the UE may send modulation symbols to the BS. The modulation symbols may have been selected from the constellation corresponding to the MCS index.

FIG. 10 illustrates an example flow diagram of a data-aided transmission method 1000 in accordance with example embodiments of the present disclosure. The embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of data-aided transmission could be used without departing from the scope of this disclosure.

The data-aided transmission method 1000 as shown in FIG. 10 may be performed by a BS (e.g., a gNB 101-103 of FIGS. 1 and 2). It may also be performed in tandem with the data-aided transmission method 900 performed by a UE.

As shown in the example of FIG. 10, the method 1000 begins at step 1002. At step 1002, a BS may receive a capability information from a UE. The capability information may include its support of data-aided transmission.

At step 1004, the BS may send a data-aided transmission configuration information to the UE. The data-aided transmission configuration information may include information such as enabling/disabling of the mapping between an MCS index and a data-aided transmission method.

In one embodiment, a BS may configure a UE to support data-aided transmission methods. Table 3 shows an example of modifying the PUSCH-Config IE to indicate all of the data-aided transmission methods that a UE can support. In this example, dataAidedTx may correspond to a flag that, when enabled, allows a UE to apply a data-aided transmission method. Further, dmrs-dataAidedTx may correspond to an ID in a pre-defined list of DMRS patterns for data-aided transmission, and constellationID-dataAidedTx may correspond to an ID in a pre-defined list of modulation methods for data-aided transmission. As another example, a single ID in a pre-defined list of data-aided transmission methods can be provided, where each data-aided transmission method corresponds to a given DMRS pattern and modulation method. In addition, precoder-dataAidedTx may correspond to an ID in a pre-defined list of multi-antenna precoders for data-aided transmission.

TABLE 3
An Example PUSCH-Config IE Modification

PUSCH-Config : := SEQUENCE {

| | |
|---|---|
| dataScramblingIdentityPUSCH | INTERGER (0..1023) OPTIONAL, -- Need S |

...,

| | |
|---|---|
| dataAidedTx | ENUMERATED {enabled, disabled} OPTIONAL, -- Need S |
| dmrs-dataAidedTx | INTEGER (1..numDMRSPatternDataAidedTx) OPTIONAL, |
| | -- Need S |
| constellationID-dataAidedTx | INTEGER (1..numConstellationsDataAidedTx) OPTIONAL, |
| | -- Need S |
| precoder-dataAidedTx | INTEGER (1..numPrecodersDataAidedTx) OPTIONAL, |
| | -- Need S |

}

Table 4 shows an example of defining a DMRS-DataAidedTxUplinkConfig IE to configure a UE with a particular DMRS pattern for data-aided transmission. In this example, for each subband (SB), dataAidedTx may determine whether data-aided transmission is utilized. If the data-aided transmission is utilized for a given SB, then the corresponding DMRS pattern can be configured to be periodic, semi-persistent, or aperiodic. A distinct RS density for the data-aided transmission can be defined for each SB via timeFreqAllocation, where DMRS-Sym represents a tuple of (OFDM symbol index, RS density) values. One tuple may be specified for each OFDM symbol in a slot.

TABLE 4
An Example DMRS-DataAidedTxUplinkConfig IE

DMRS-DataAidedTxUplinkConfig : := SEUQENCE {

| | |
|---|---|
| dmrs-Type | ENUMERATED {type2} OPTIONAL, -- Need S |

...,

| | |
|---|---|
| dataAidedTx | SEQUENCE {SIZE (1..numSubBands)} OF BOOLEAN |
| resourceType | SEQUENCE {SIZE (1..numSubBands)} OF CHOICE { |
| aperiodic | SEQUENCE { |
| slotOffset | INTEGER (1..32) OPTIONAL, -- Need S |

},

| | |
|---|---|
| semi-persistent | SEQUENCE { |
| slotOffset | INTEGER (1..32) OPTIONAL, -- Need S |
| periodicity | INTEGER (1..maxPeriodicity) OPTIONAL, -- Need S |

},

| | |
|---|---|
| periodic | SEQUENCE { |
| slotOffset | INTEGER (1..32) OPTIONAL, -- Need S |
| periodicity | INTEGER (1..maxPeriodicity) OPTIONAL, -- Need S |

```
        }
    },
```

| | |
|---|---|
| timeFreqAllocation | SEQUENCE {SIZE (1..numSubBands)} OF DMRS-Slot, |
| DMRS-Slot | : := SEQUENCE {SIZE (1..numSymInSlot)} OF DMRS-Sym |
| DMRS-Sym | : := SEQUENCE { |
| SymIndex | INTEGER (1..32) OPTIONAL, -- Need S |
| Density | INTEGER (1..numDataAidedDensity) OPTIONAL, -- Need S |

}
}

In another embodiment, a BS can configure a UE with DMRS frequency hopping for data-aided transmission. Table 5 shows an example of defining an IE DMRS-DataAidedTxUplinkConfig to configure DMRS frequency hopping for data-aided transmission. For DMRS-DataAidedTxUplinkConfig, frequencyHopping, if present, may determine whether a particular DMRS pattern for data-aided transmission hops within a slot or between slots. Further, frequencyHoppingOffset, if present, may determine the hopping pattern of this DMRS pattern for data-aided transmission across the available SBs. If a hopping pattern of a DMRS pattern for data-aided transmission is enabled, then the UE can use this hopping pattern to determine the DMRS density within a particular SB for a particular slot.

TABLE 5
An Example DMRS-DataAidedTxUplinkConfig IE

DMRS-DataAidedTxUplinkConfig : := SEUQENCE {

| | |
|---|---|
| dmrs-Type | ENUMERATED {type2} OPTIONAL, -- Need S |

...,

| | |
|---|---|
| frequencyHopping | EUMERATED {intraSlot, interSlot} OPTIONAL, -- Need S |
| frequencyHoppingOffset | SEQUENCE (SIZE (1..numHops)) OF INTEGER |
| | (1..numSubBands) OPTIONAL, -- Need M |
| timeFreqAllocation : := | SEQUENCE (SIZE (1..numSymInSlot)) OF DMRS-Sym |

DMRS-Sym : := SEQUENCE {

| | |
|---|---|
| SymIndex | INTEGER (1..32) OPTIONAL, -- Need S |
| Density | INTEGER (1..numDataAidedDensity) OPTIONAL, -- Need S |

}
}

At step 1006, the BS may send an MCS indication message for a data-aided transmission method to the UE. The BS may use a regular DCI format for this MCS indication message. It may also define a new DCI format for this MCS indication message. In one example, the UE may use this MCS indication message to determine an MCS index. In another example, the UE may autonomously determine an MCS index. Table 6 shows an example of modifying a DCI format to indicate all of the data-aided transmission methods that a UE can support. In this example, one bit may be used to indicate whether data-aided transmission is configured, four bits may be used to indicate a DMRS pattern for data-aided transmission, and/or four bits may be used to indicate a modulation method for data-aided transmission. In addition, four bits may be used to indicate a multi-antenna precoder for data-aided transmission.

TABLE 6
An Example Modified DCI Format

| Field (Item) | Bits | Reference |
|---|---|---|
| Identifier for DCI | 1 | |
| formats | | |
| * * * | | |
| Data-aided Tx Indicator | 1 | Whether data-aided Tx is configured |
| | | or not |
| DMRS for data-aided Tx | 4 | DMRS allocation for data-aided Tx |
| | | (define DMRS lookup table with |
| | | 2\hat{ }(# bits)) entries |
| Constellation for | 4 | Define constellation lookup table |
| data-aided Tx | | with 2\hat{ }(#bits) entries |
| Precoder for data- | 4 | Define precoder lookup table with |
| aided Tx | | 2\hat{ }(#bits) entries |
| UL-SCH indicator | 1 | 0: UL-SCH not transmitted on PUSCH |
| | | 1: UL-SCH transmitted on PUSCH |

At step 1008, the BS may receive modulation symbols from the UE. The modulation symbols may have been selected from the constellation corresponding to the MCS index.

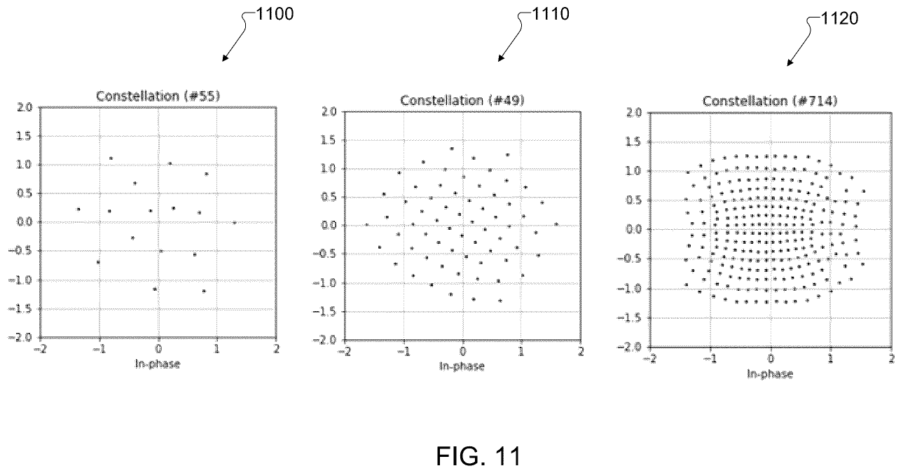

FIG. 11 illustrates example modulation constellations 1100, 1110, 1120 that can be configured for data-aided transmission in accordance with example embodiments of the present disclosure. The example modulation constellations 1100, 1110, 1120 shown in FIG. 11 are for illustration only, and the modulation constellations 1100, 1110, 1120 could have the same or similar configuration. However, FIG. 11 does not limit the scope of this disclosure to any particular modulation constellations.

The example modulation constellation 1100 shown in FIG. 11 may correspond to the ID “64ary_16 dB_const1” in Table 1. The example modulation constellation 1110 shown in FIG. 11 may correspond to the ID “256ary_20 dB_const3” in Table 1. The example modulation constellation 1120 shown in FIG. 11 may correspond to the ID “1024ary_24 dB_const5” in Table 1.

In another example, for a given modulation order, multiple distinct modulation constellations can be configured for data-aided transmission.

In one embodiment, a BS may configure a UE to send an indication of its supported data-aided transmission methods via MAC CE activation command.

In one embodiment, a BS may configure a UE to send an indication of its supported data-aided transmission methods via DCI.

FIG. 12 illustrates example DMRS patterns 1200, 1210 that can be configured for data-aided transmission in accordance with example embodiments of the present disclosure. The example DMRS patterns 1200, 1210 shown in FIG. 12 are for illustration only, and DMRS patterns 1200, 1210 could have the same or similar configuration. However, FIG. 12 does not limit the scope of this disclosure to any particular modulation constellations.

Both example DMRS patterns 1200, 1210 shown in FIG. 12 support tracking of time-frequency channel variations since the REs 502 with RS are evenly spaced in both time and frequency. Further, both example DMRS patterns 1200, 1210 have less RS overhead than the example 500 in FIG. 5. That is, 6 and 4 out of 168 REs in the example DMRS patterns 1200, 1210, respectively, include the RS as compared to 12 out of the 168 REs in the example RS pattern 500 in FIG. 5.

The example DMRS pattern 1210 may have even less RS overhead than that of the example DMRS pattern 1200.

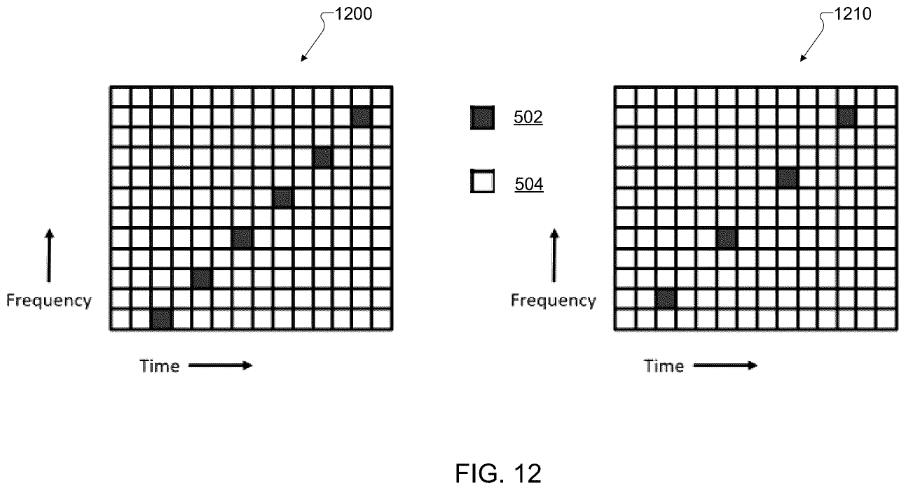

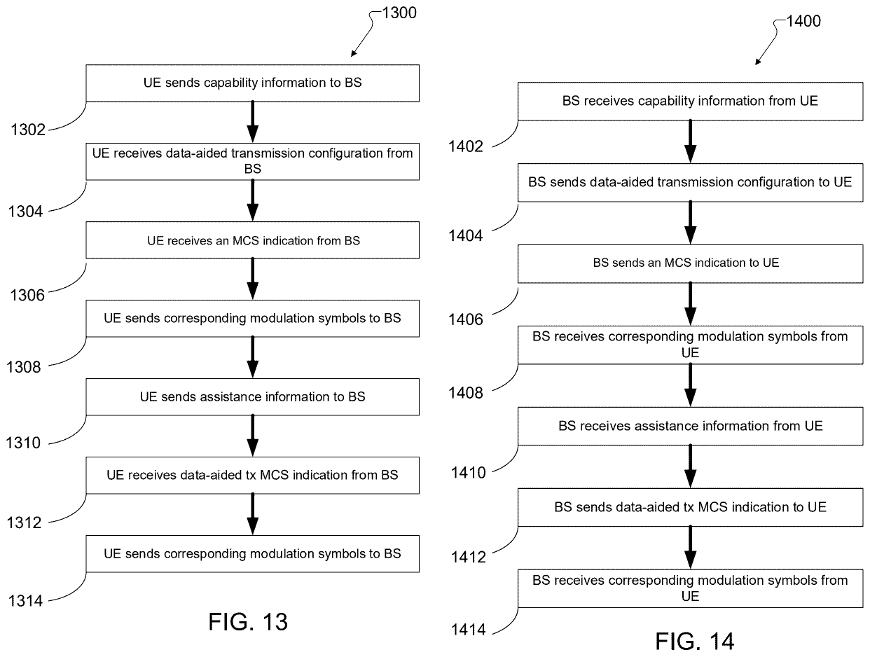

FIGS. 13 and 14 illustrate example data-aided transmission methods 1300, 1400 as performed by a UE and a BS, respectively, in accordance with example embodiments of the present disclosure. The embodiments of the methods illustrated in FIGS. 13 and 14 are for illustration only. One or more of the components illustrated in FIGS. 13 and 14 may be implemented in specialized circuitry configured to perform the noted functions or one or more of the components may be implemented by one or more processors executing instructions to perform the noted functions. Other embodiments of data-aided transmission could be used without departing from the scope of this disclosure.

In FIGS. 13 and 14, a UE may send its capability information regarding data-aided transmission to a BS at step 1302, and a BS may receive the capability information from the UE at step 1402. The BS can use that information to determine whether or not to send an MCS indication message for a data-aided transmission method to the UE. Alternatively, the UE may send additional information to the BS to assist in making that determination. In this alternative approach, the UE may convey information that may or may not already be available to the BS.

FIG. 13 illustrates the example data-aided transmission method 1300 for operations at a UE to support BS determination of an MCS indication for data-aided transmission. In the example shown in FIG. 13, the method 1300 begins at step 1302. At step 1302, the UE may send its capability information to a BS, including the support of data-aided transmission methods.

At step 1304, the UE may receive a data-aided transmission configuration information from the BS. The data-aided transmission configuration information can include information such as enabling/disabling of the mapping between an MCS index and a data-aided transmission method.

At step 1306, the UE may receive an MCS indication message from the BS for a pilot-aided transmission method. The BS can use regular DCI format for this MCS indication message. It can also define a new DCI format for this MCS indication message. In one example, a UE uses this MCS indication message to determine an MCS index. In another example, a UE may autonomously determine an MCS index.

At step 1308, the UE may send modulation symbols to the BS. The modulation symbols may have been selected from the constellation corresponding to the MCS index. At step 1310, the UE may send or report an assistance information (also referred to as UE assistance information) to the BS. The UE assistance information can be used by the BS to determine an MCS indication.

The UE assistance information report may provide several advantages over relying on other signaling. For example, the BS can use an SRS to estimate the UL (and DL, depending on reciprocity) channel from the UE. The minimum periodicity of an SRS may be 2 ms. In contrast, the spacing between consecutive DMRSs can be configured to be less than 1 ms. Thus, the UE can perform finer-grained measurements of the DL channel using the received DMRS, compared to the BS measuring the UL channel using received SRS.

As another example, the UE may report local information that may not be available to the BS. The UE can use its cameras to determine that a vehicle may cross its line-of-sight with the BS in T seconds. The UE may then report this information to the BS and make a pre-emptive recommendation for a transmission mode switch in T seconds (e.g. switching from a data-aided transmission method to a pilot-aided transmission method).

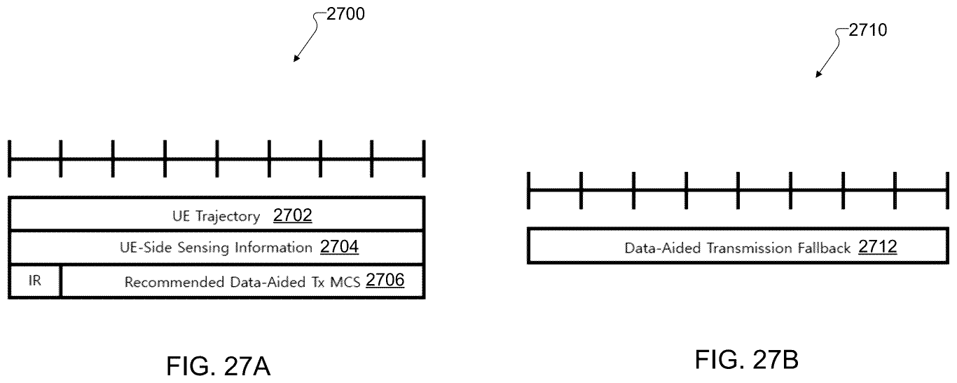

In one embodiment, a new MAC CE can be defined for the UE assistance information report as illustrated in FIG. 27A. This MAC CE can be identified by a MAC subheader with a logical channel ID that can be specified in Table 6.2.1-2 in [3]. This MAC CE can have a variable size and include the following fields:
UE Trajectory: This field indicates the trajectory of a UE.
   In one example, this could be a set of waypoints for its trajectory based on the programmed destination in its mapping application.
UE-Side Sensing Information: This field indicates information from the sensors on a UE.
   In one example, this could be a message from an onboard radar that the currently-blocked line-of-sight path to a BS will be clear in T seconds.
IR: This field indicates the presence of the octet containing the Recommended Data-Aided Tx MCS field. If the IR field is set to 1, the octet containing the Recommended Data-Aided Tx MCS field is present. If the IR field is set to 0, the octet containing the Recommended Data-Aided Tx MCS field is not present.
Recommended Data-Aided Tx MCS: This field indicates a UE's recommended MCS index for data-aided transmission, e.g. an index to a table of MCS values for data-aided transmission methods.

In one embodiment, a new MAC CE can be defined for the data-aided transmission method fallback indication as illustrated in FIG. 27B. This MAC CE can be identified by a MAC subheader with a logical channel ID. This MAC CE can have a variable size and includes the following fields:
Data-Aided Transmission Fallback: This field indicates the MCS index that a UE is requesting, e.g. an index to a table of MCS values for pilot-aided transmission methods.

Referring back to the method 1300, at step 1312, the UE may receive an MCS indication message from the BS for a data-aided transmission method. The BS can use a regular DCI format for this MCS indication message. It can also define a new DCI format for this MCS indication message. In one example, the UE may use this MCS indication message to determine an MCS index. In another example, the UE may autonomously determine an MCS index.

At step 1314, the UE may send modulation symbols to the BS. The modulation symbols may have been selected from the constellation corresponding to the MCS index.

In another example, the BS can pre-determine/configure information about the switching time to a data-aided transmission method. In this case, operations 1310 and 1312 may be skipped, and the UE may send modulation symbols from a constellation for a data-aided transmission method to the BS at a pre-determined/configured time at step 1314.

FIG. 14 illustrates an example data-aided transmission method 1400 for operations at a BS to support BS determination of an MCS indication for data-aided transmission.

In the example shown in FIG. 14, the method 1400 begins at step 1402. At step 1402, the BS may receive capability information from a UE, including the support of data-aided transmission methods. At step 1404, the BS may send a data-aided transmission configuration information to the UE. The data-aided transmission configuration information may include information such as enabling/disabling of the mapping between an MCS index and a data-aided transmission method.

At step 1406, the BS may send an MCS indication message to the UE for a pilot-aided transmission method. The BS may use a regular DCI format for this MCS indication message. It may also define a new DCI format for this MCS indication message. In one example, the UE may use this MCS indication message to determine an MCS index. In another example, the UE may autonomously determine an MCS index.

At step 1408, the BS may receive modulation symbols from the UE. The modulation symbols may have been selected from the constellation corresponding to the MCS index. At step 1410, the BS may receive an assistance information from the UE. The assistance information can be used by the BS to determine an MCS indication.

At step 1412, the BS may send an MCS indication message to the UE for a data-aided transmission method. The BS may use a regular DCI format for this MCS indication message. It may also define a new DCI format for this MCS indication message. In one example, the UE may use this MCS indication message to determine an MCS index. In another example, the UE may autonomously determine an MCS index. At step 1414, the BS may receive modulation symbols from the UE. The modulation symbols may have been selected from the constellation corresponding to the MCS index.

In another example, the BS may pre-determine/configure information about the switching time to a data-aided transmission method. In this case, steps 1410 and 1412 may be skipped, and the BS may receive modulation symbols from a constellation for a data-aided transmission method from the UE at a pre-determined/configured time at step 1414.

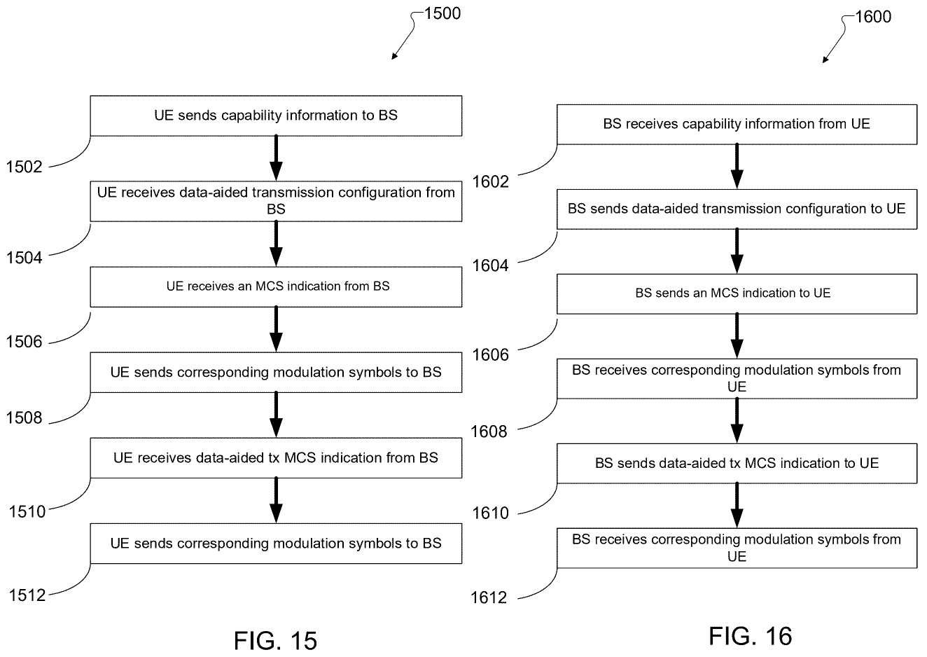

FIG. 15 illustrates an example data-aided transmission method 1500 in accordance with example embodiments of the present disclosure. The method 1500 may be performed by a UE (e.g., UE 111-116 of FIGS. 1 and 3) to support BS configuration of an MCS indication for data-aided transmission. The embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of data-aided transmission could be used without departing from the scope of this disclosure.

In the example shown in FIG. 15, the method 1500 begins at step 1502. At step 1502, the UE may send its capability information to a BS, including the support of data-aided transmission methods. At step 1504, the UE may receive a data-aided transmission configuration information from the BS, which can include information such as enabling/disabling of the mapping between an MCS index and a data-aided transmission method. At step 1506, the UE may receive an MCS indication message from the BS for a pilot-aided transmission method. The BS may use a regular DCI format for this MCS indication message. It may also define a new DCI format for this MCS indication message. In one example, the UE may use this MCS indication message to determine an MCS index. In another example, the UE may autonomously determine an MCS index.

At step 1508, the UE may send modulation symbols to the BS. The modulation symbols may have been selected from the constellation corresponding to the MCS index. At step 1510, the UE may receive an MCS indication message from the BS for a data-aided transmission method. The BS may use a regular DCI format for this MCS indication message. It may also define a new DCI format for this MCS indication message. In one example, the UE may use this MCS indication message to determine an MCS index. In another example, the UE may autonomously determine an MCS index.

At step 1512, the UE may send modulation symbols to the BS. The modulation symbols may have been selected from the constellation corresponding to the MCS index.

In another example, a BS may pre-determine/configure information about the switching time to a data-aided transmission method. In this case, step 1510 may be skipped and a UE may send modulation symbols from a constellation for a data-aided transmission method to the BS at a pre-determined/configured time at step 1512.

FIG. 16 illustrates an example data-aided transmission method 1600 in accordance with example embodiments of the present disclosure. The method 1600 may be performed by a BS (e.g., a gNB 101-103 of FIGS. 1 and 2) to support BS configuration of an MCS indication for data-aided transmission. The embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of data-aided transmission could be used without departing from the scope of this disclosure.

In the example shown in FIG. 16, the method 1600 begins at step 1602. At step 1602, a BS may receive a capability information from a UE, including the support of data-aided transmission methods.

At step 1604, the BS may send a data-aided transmission configuration information to the UE. The data-aided transmission configuration information may include information such as enabling/disabling of the mapping between an MCS index and a data-aided transmission method. At step 1606, the BS may send an MCS indication message to the UE for a pilot-aided transmission method. The BS may use a regular DCI format for this MCS indication message. It may also define a new DCI format for this MCS indication message. In one example, the UE may use this MCS indication message to determine an MCS index. In another example, the UE may autonomously determine an MCS index.

At step 1608, the BS may receive modulation symbols from the UE. The modulation symbols may have been selected from the constellation corresponding to the MCS index. At step 1610, the BS may send an MCS indication message to the UE for a data-aided transmission method. The BS may use a regular DCI format for this MCS indication message. It may also define a new DCI format for this MCS indication message. In one example, the UE may use this MCS indication message to determine an MCS index. In another example, the UE may autonomously determine an MCS index. At step 1612, the BS may receive modulation symbols from the UE. The modulation symbols may have been selected from the constellation corresponding to the MCS index.

In another example, the BS may pre-determine/configure information about the switching time to a data-aided transmission method. In this case, step 1610 may be skipped, and the BS may receive modulation symbols from a constellation for a data-aided transmission method from a UE at a pre-determined/configured time at step 1612.

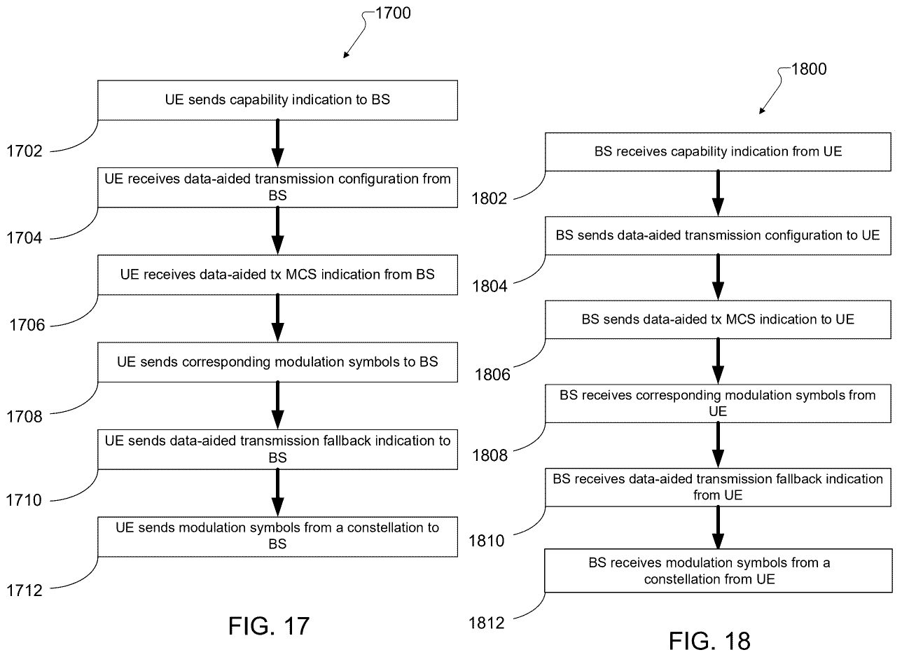

FIG. 17 illustrates an example method 1700 for operations at a UE (e.g., a UE 111-116 of FIGS. 1 and 3) to support UE-initiated fallback to a pilot-aided transmission method in accordance with example embodiments of the present disclosure. The embodiment of the method illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of fallback to pilot-aided transmission could be used without departing from the scope of this disclosure.

In the example shown in FIG. 17, the method 1700 begins at step 1702. At step 1702, the UE may send its capability information to a BS, including the support of data-aided transmission methods. At step 1704, the UE may receive a data-aided transmission configuration information from the BS. The data-aided transmission configuration information may include information such as enabling/disabling of the mapping between an MCS index and a data-aided transmission method.

At step 1706, the UE may receive an MCS indication message from the BS for a data-aided transmission method. The BS may use a regular DCI format for this MCS indication message. The BS may also define a new DCI format for this MCS indication message. In one example, the UE may use this MCS indication message to determine an MCS index. In another example, the UE may autonomously determine an MCS index.

At step 1708, the UE may send modulation symbols to the BS. The modulation symbols may have been selected from the constellation corresponding to the MCS index. At step 1710, the UE may send a data-aided transmission fallback indication to the BS. At step 1712, the UE may send modulation symbols from a constellation that corresponds to a pilot-aided transmission method to the BS.

In another example, the BS may pre-determine/configure information about the switching time to a pilot-aided transmission method. In this case, step 1710 may be skipped, and the UE may send modulation symbols from a constellation for a pilot-aided transmission method to the BS at a pre-determined/configured time at step 1712.

In another example, between steps 1710 and 1712, the UE may perform step 1711. In step 1711, the UE may receive an MCS indication message from the BS for a pilot-aided transmission method. The MCS index that corresponds to this message can differ from the MCS index that corresponds to the fallback indication at step 1710.

FIG. 18 illustrates an example method 1800 for operations at a BS to support UE-initiated fallback to a pilot-aided transmission method in accordance with example embodiments of the present disclosure. The embodiment of the method illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of fallback to pilot-aided transmission could be used without departing from the scope of this disclosure.

In the example shown in FIG. 18, the method 1800 begins at step 1802. At step 1802, the BS may receive a capability information from a UE, including the support of data-aided transmission methods. At step 1804, the BS may send a data-aided transmission configuration information to the UE. The data-aided transmission configuration information may include information such as enabling/disabling of the mapping between an MCS index and a data-aided transmission method.

At step 1806, the BS may send an MCS indication message for a data-aided transmission method to the UE. The BS may use a regular DCI format for this MCS indication message. It may also define a new DCI format for this MCS indication message. In one example, the UE may use this MCS indication message to determine an MCS index. In another example, the UE may autonomously determine an MCS index. At step 1808, the BS may receive modulation symbols from the UE. The modulation symbols may have been selected from the constellation corresponding to the MCS index. At step 1810, the BS may receive a data-aided transmission fallback indication from the UE.

At step 1812, the BS may receive modulation symbols from a constellation that corresponds to a pilot-aided transmission method from the UE.

In another example, the BS may pre-determine/configure information about the switching time to a pilot-aided transmission method. In this case, step 1810 may be skipped, and the BS may receive modulation symbols from a constellation for a pilot-aided transmission method from the UE at a pre-determined/configured time at step 1812.

In another example, between steps 1810 and 1812, the BS may perform step 1811. At step 1811, the BS may send an MCS indication message to the UE for a pilot-aided transmission method. The MCS index that corresponds to this message can differ from the MCS index that corresponds to the fallback indication at step 1810.

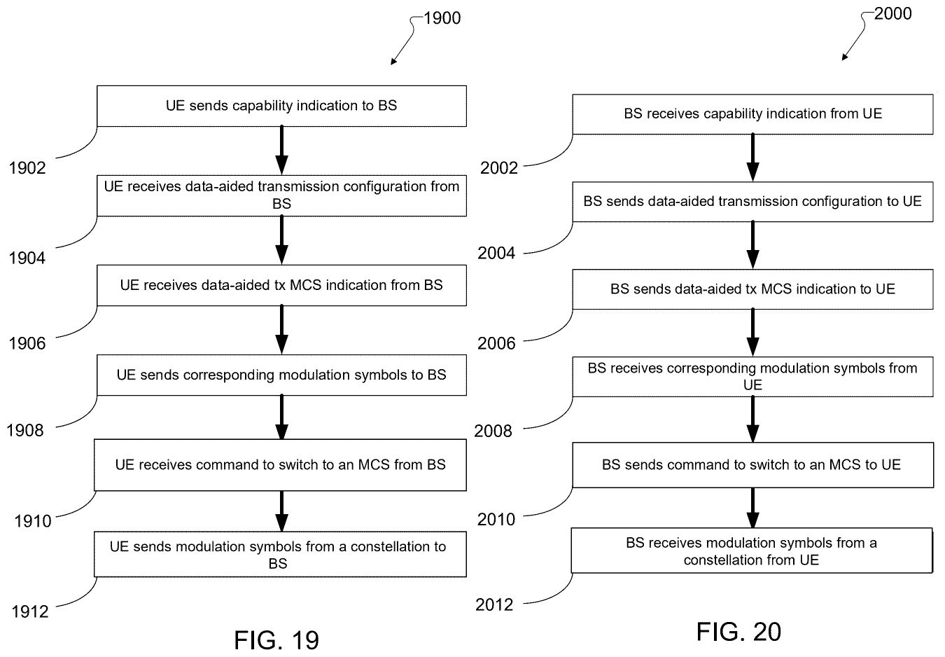

FIG. 19 illustrates an example method 1900 for operations at a UE to support BS-initiated fallback to a pilot-aided transmission method in accordance with example embodiments of the present disclosure. The embodiment of the method illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of fallback to pilot-aided transmission could be used without departing from the scope of this disclosure.

In the example shown in FIG. 19, the method 1900 begins at step 1902. At step 1902, a UE may send its capability information to a BS, including the support of data-aided transmission methods. At step 1904, a UE may receive a data-aided transmission configuration information from the BS. The data-aided transmission configuration information may include information such as enabling/disabling of the mapping between an MCS index and a data-aided transmission method. At step 1906, a UE may receive an MCS indication message from the BS for a data-aided transmission method. The BS may use a regular DCI format for this MCS indication message and it may also define a new DCI format for this MCS indication message. In one example, the UE may use this MCS indication message to determine an MCS index. In another example, the UE may autonomously determine an MCS index.

At step 1908, a UE may send modulation symbols to the BS, which may have been selected from the constellation corresponding to the MCS index. At step 1910, the UE may receive a command from the BS to switch to the pilot-aided transmission method. In one example, a BS can configure a UE to switch to a pilot-aided transmission method via a PDCCH order, where a new DCI format can be defined and this PDCCH order can be triggered by this new DCI format. In another example, the BS can configure the UE to switch to the pilot-aided transmission method via an RRC reconfiguration message. At step 1912, the UE may send modulation symbols from a constellation that corresponds to the pilot-aided transmission method to the BS.

In another example, the BS may predetermine and/or configure information about the switching time to the pilot-aided transmission method. In this case, step 1910 may be skipped, and the UE may send modulation symbols from a constellation for the pilot-aided transmission method to the BS at the pre-determined and/or configured time in step 1912.

FIG. 20 illustrates an example method 2000 for operations at a BS to support BS-initiated fallback to a pilot-aided transmission method in accordance with example embodiments of the present disclosure. The embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of fallback to pilot-aided transmission could be used without departing from the scope of this disclosure.

In the example shown in FIG. 20, the method 2000 begins at step 2002. At step 2002, a BS may receive a capability information from a UE, including the support of data-aided transmission methods. At step 2004, the BS may send a data-aided transmission configuration information to the UE. The data-aided transmission configuration information may include information such as enabling/disabling of the mapping between an MCS index and a data-aided transmission method. At step 2006, the BS may send an MCS indication message for a data-aided transmission method to the UE. The BS can use a regular DCI format for this MCS indication message, and it may also define a new DCI format for this MCS indication message.

In one example, the UE may use this MCS indication message to determine an MCS index. In another example, the UE autonomously determines an MCS index. At step 2008, the BS may receive modulation symbols from the UE, which may have been selected from the constellation corresponding to the MCS index. At step 2010, the BS may send a command to the UE to switch to the pilot-aided transmission method. In one example, the BS may configure the UE to switch to the pilot-aided transmission method via a PDCCH order, where a new DCI format can be defined and this PDCCH order can be triggered by this new DCI format. In another example, the BS can configure the UE to switch to the pilot-aided transmission method via an RRC reconfiguration message. At step 2012, the BS may receive modulation symbols from a constellation that corresponds to the pilot-aided transmission method from the UE.

In another example, the BS may pre-determine and/or configure information about the switching time to the pilot-aided transmission method. In this case, step 2010 may be skipped, and the BS may receive modulation symbols from a constellation for the pilot-aided transmission method from the UE at a pre-determined/configured time at step 2012.

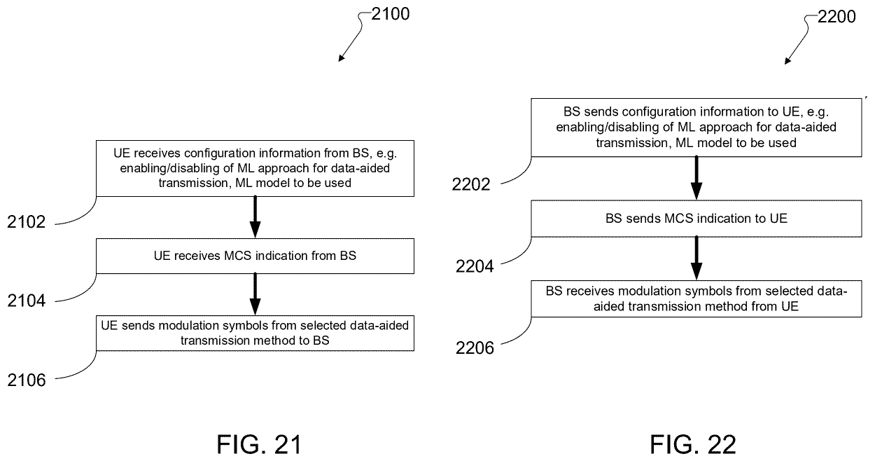

FIG. 21 illustrates an example method 2100 for operations at a UE to support UE-side ML-based data-aided transmission method selection in accordance with example embodiments of the present disclosure. The embodiment of the method illustrated in FIG. 21 is for illustration only. One or more of the components illustrated in FIG. 21 may be implemented in specialized circuitry configured to perform the noted functions or one or more of the components may be implemented by one or more processors executing instructions to perform the noted functions. Other embodiments of data-aided transmission could be used without departing from the scope of this disclosure

In the example shown in FIG. 21, the method 2100 begins at step 2102. At step 2102, a UE may receive a configuration information from a BS. The configuration information may include an ML-related configuration information such as enabling/disabling of an ML approach for a data-aided transmission method selection, an ML model to be used, trained model parameters, and/or whether model parameter updates reported by the UE are to be used or not. At step 2104, the UE may receive an MCS indication from the BS. The BS may use a regular DCI format for this MCS indication message, and it may also define a new DCI format for this MCS indication message.

At step 2106, the UE may use an ML-based method to determine a data-aided transmission method that corresponds to this MCS indication, and send modulation symbols from the determined data-aided transmission method to the BS.

FIG. 22 illustrates an example method 2200 for operations at a BS to support a UE-side ML-based data-aided transmission method selection in accordance with example embodiments of the present disclosure. The embodiment of the method illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of data-aided transmission could be used without departing from the scope of this disclosure.

In the example shown in FIG. 22, the method 2200 begins at step 2202. At step 2202, a BS may send a configuration information to a UE. The configuration information may include an ML-related configuration information such as enabling/disabling of an ML approach for data-aided transmission method selection, an ML model to be used, trained model parameters, and/or whether model parameter updates reported by the UE are to be used or not. At step 2204, the BS may send an MCS indication to the UE. The BS may use a regular DCI format for this MCS indication message, and may also define a new DCI format for this MCS indication message. At step 2206, the BS may receive modulation symbols from a data-aided transmission method from the UE, where the UE uses an ML-based method to determine a data-aided transmission method that corresponds to this MCS indication.

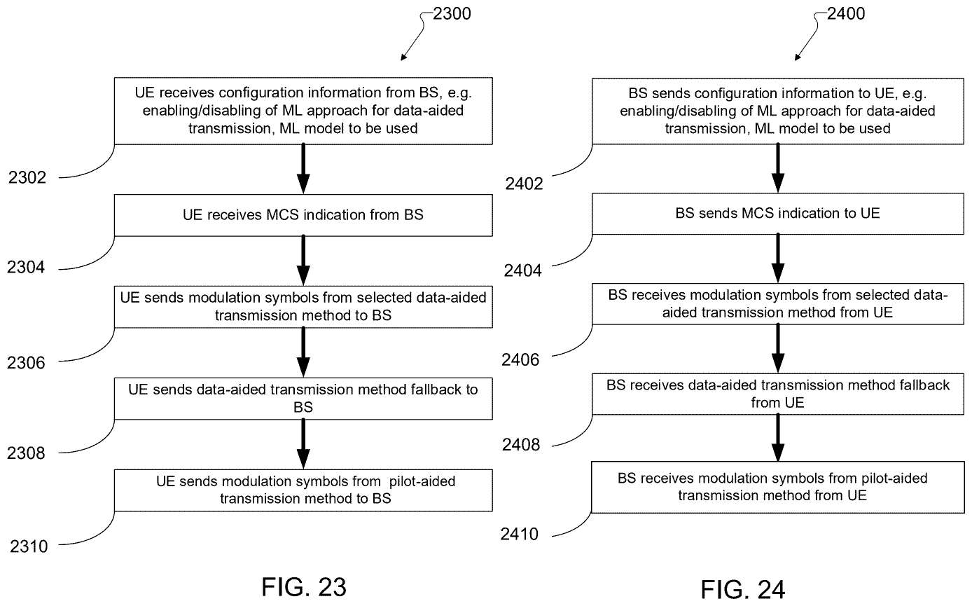

FIG. 23 illustrates an example method 2300 for operations at a UE to support a UE-initiated fallback to the pilot-aided transmission method in accordance with example embodiments of the present disclosure. The embodiment of the method illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of fallback to pilot-aided transmission could be used without departing from the scope of this disclosure

In the example shown in FIG. 23, the method 2300 begins at step 2302. At step 2302, a UE may receive a configuration information from a BS. The configuration information may include an ML-related configuration information such as enabling/disabling of an ML approach for data-aided transmission method selection, an ML model to be used, trained model parameters, and/or whether model parameter updates reported by the UE are to be used or not. At step 2304, the UE may receive an MCS indication from the BS. The BS may use a regular DCI format for this MCS indication message, and also define a new DCI format for this MCS indication message.

At step 2306, the UE may use an ML-based method to determine a data-aided transmission method that corresponds to this MCS indication, and send modulation symbols from the determined data-aided transmission method to the BS. At step 2308, the UE may send a message to the BS that corresponds to a request to fall back to the pilot-aided transmission method. At step 2310, the UE may send modulation symbols from the pilot-aided transmission method to the BS.

FIG. 24 illustrates an example method 2400 for operations at a BS to support UE-initiated fallback to a pilot-aided transmission method in accordance with example embodiments of the present disclosure. The embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of fallback to pilot-aided transmission could be used without departing from the scope of this disclosure.

In the example shown in FIG. 24, the method 2400 begins at step 2402. At step 2402, the BS may send a configuration information to a UE, which can include an ML-related configuration information such as enabling/disabling of an ML approach for data-aided transmission method selection, an ML model to be used, trained model parameters, and/or whether model parameter updates reported by the UE are to be used or not. At step 2404, the BS may send an MCS indication to the UE. The BS may use a regular DCI format for this MCS indication message, and also define a new DCI format for this MCS indication message. At step 2406, the BS may receive modulation symbols from a data-aided transmission method from the UE, where the UE uses an ML-based method to determine a data-aided transmission method that corresponds to this MCS indication. At step 2408, the BS may receive a message from the UE that corresponds to a request to fall back to a pilot-aided transmission method. At step 2410, the BS may receive modulation symbols from a pilot-aided transmission method from the UE.

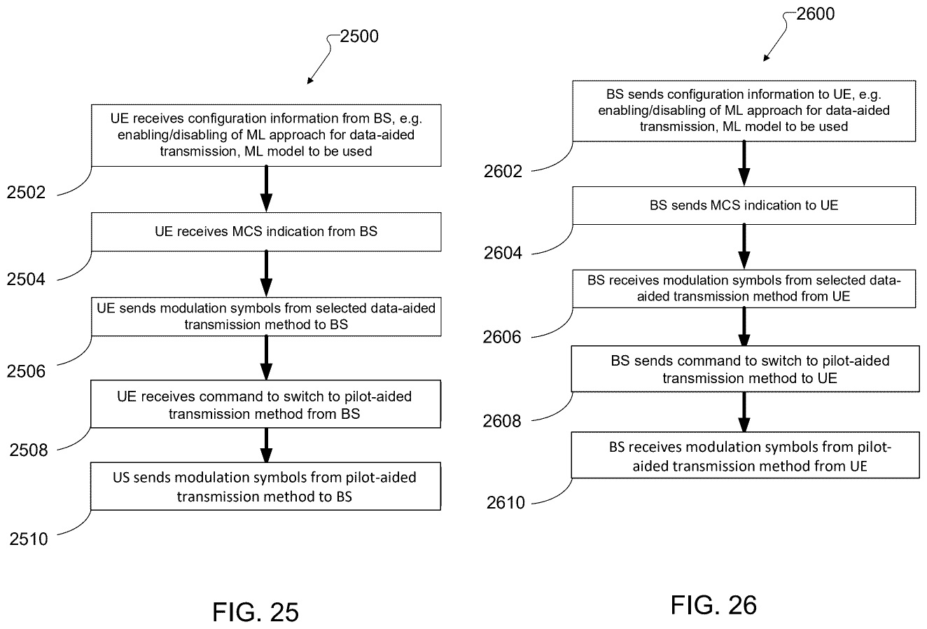

FIG. 25 illustrates an example method 2500 for operations at a UE to support a BS-initiated fallback to the pilot-aided transmission method in accordance with example embodiments of the present disclosure. The embodiment of the method illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of fallback to pilot-aided transmission could be used without departing from the scope of this disclosure.

In the example shown in FIG. 25, the method 2500 begins at step 2502. At step 2502, the UE may receive a configuration information from a BS. The configuration information may include an ML-related configuration information such as enabling/disabling of an ML approach for data-aided transmission method selection, an ML model to be used, trained model parameters, and/or whether model parameter updates reported by the UE are to be used or not. At step 2504, the UE may receive an MCS indication from a BS. The BS may use a regular DCI format for this MCS indication message. The BS may also define a new DCI format for this MCS indication message. At step 2506, the UE may use an ML-based method to determine a data-aided transmission method that corresponds to this MCS indication. The UE may then send modulation symbols from the determined data-aided transmission method to the BS. At step 2508, the UE may receive a message from the BS that corresponds to a command to fall back to a pilot-aided transmission method. At step 2510, the UE may send modulation symbols from the pilot-aided transmission method to the BS.

FIG. 26 illustrates an example method 2600 for operations at a BS to support a BS-initiated fallback to the pilot-aided transmission method in accordance with example embodiments of the present disclosure. The embodiment of the method illustrated in FIG. 26 is for illustration only. One or more of the components illustrated in FIG. 26 may be implemented in specialized circuitry configured to perform the noted functions or one or more of the components may be implemented by one or more processors executing instructions to perform the noted functions. Other embodiments of fallback to pilot-aided transmission could be used without departing from the scope of this disclosure.

In the example shown in FIG. 26, the method 2600 begins at step 2602. At step 2602, the BS may send a configuration information to a UE, which can include ML-related configuration information such as enabling/disabling of an ML approach for data-aided transmission method selection, an ML model to be used, trained model parameters, and/or whether model parameter updates reported by the UE are to be used or not. At step 2604, the BS may send an MCS indication to the UE. The BS may use a regular DCI format for this MCS indication message. The BS may also define a new DCI format for this MCS indication message. At step 2606, the BS may receive modulation symbols from a data-aided transmission method from the UE, where the UE uses an ML-based method to determine a data-aided transmission method that corresponds to this MCS indication. At step 2608, the BS may send a message to the UE that corresponds to a command to fall back to a pilot-aided transmission method. At step 2610, the BS may receive modulation symbols from a pilot-aided transmission method from the UE.

FIG. 27A-27B illustrate example MAC CEs 2700, 2710 in accordance with example embodiments of the present disclosure. FIG. 27A shows an example modified MAC CE 2700 for a UE assistance information report, and FIG. 27B shows an example modified MAC CE 2710 for the data-aided transmission method fallback indication.

In the example MAC CE 2700 shown in FIG. 27A, each of the UE Trajectory field 2702 and UE-Side Sensing Information field 2704 has a length of 8 bits, and the Recommended Data-Aided Tx MCS field has a length of 7 bits.

In one embodiment, a BS can configure a UE to send a UE assistance information report via DCI.

In the MAC CE 2710 shown in FIG. 27B, the Data-Aided Transmission Fallback field 2712 has a length of 8 bits.

In one embodiment, a BS can configure a UE to send a data-aided transmission method fallback indication via DCI.

In another embodiment, a BS can configure a UE to train an AI/ML-based method for data-aided transmission method selection via an RRC configuration. Table 7 shows an example of modifying an IE PUSCH-ServingCellConfig to configure training of an AI/ML-based method for data-aided transmission method selection. For PUSCH-ServingCellConfig, mlParams, if present, can include at least one set of mlTrainParams. Each set of mlTrainParams can include trained weights and biases for another UE that has trained an AI/ML-based method for data-aided transmission method selection. These trained weights and biases can assist this UE in training an AI/ML-based method for data-aided transmission method selection.

TABLE 7
An Example PUSCH-ServingCellConfig IE Modification

PUSCH-ServingCellConfig : := SEQUENCE {

| | |
|---|---|
| pusch-DataAidedTxSelector | SEQUENCE { |
| mlEnabled | BOOLEAN |
| mlAlgorithm | INTEGER (1..M) |
| mlParams | SEQUENCE (SIZE (1..numUEs)) of |
| | mlTrainParams |
| | OPTIONAL, -- Need N |

}
}

In one example, the PUSCH-ServingCellConfig IE can include the training and/or inference assistance information from other UEs, including training error (e.g. NMSE), hyperparameters (e.g. learning rate, number of training epochs, split between training and testing data, etc.), etc.

In another embodiment, a BS can configure a UE to train an AI/ML-based receiver for data-aided transmission via RRC configuration. Table 8 shows an example of modifying an IE PUSCH-ServingCellConfig to configure training of an AI/ML-based receiver for data-aided transmission. For PUSCH-ServingCellConfig, mlParams, if present, can include at least one set of mlTrainParams; each set of mlTrainParams can include trained weights and biases for another UE that has trained an AI/ML-based receiver for data-aided transmission. These trained weights and biases can assist this UE in training an AI/ML-based receiver for data-aided transmission.

TABLE 8
An Example PUSCH-ServingCellConfig IE Modification

| PUSCH-ServingCellConfig : := SEQUENCE { | |
|---|---|
| pusch-MlReceiver | SEQUENCE { |
| mlEnabled | BOOLEAN |
| mlAlgorithm | INTEGER (1..M) |
| mlParams | SEQUENCE (SIZE (1..numUEs)) of |
| | mlTrainParams |
| | OPTIONAL, -- Need N |
| } | |
| } | |

In one example, the PUSCH-ServingCellConfig IE can include the training and/or inference assistance information from other UEs, including training error (e.g. NMSE), hyperparameters (e.g. learning rate, number of training epochs, split between training and testing data, etc.), etc.

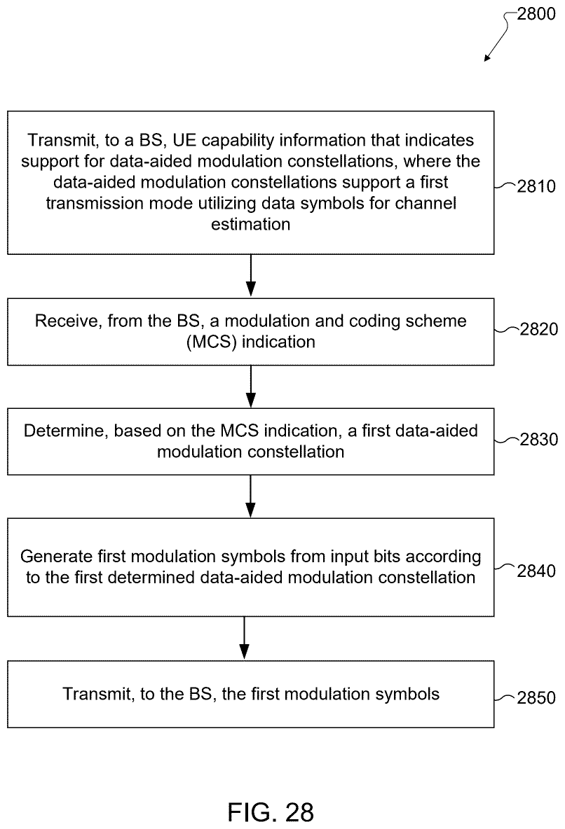

FIG. 28 illustrates an example flow chart for a data-aided communications method 2800 in accordance with example embodiments of the present disclosure. The method 2800 may be performed by a UE (e.g., a UE 111-116 of FIGS. 1 and 3). An embodiment of the method illustrated in FIG. 28 is for illustration only. One or more of the components illustrated in FIG. 28 may be implemented in specialized circuitry configured to perform the noted functions or one or more of the components may be implemented by one or more processors executing instructions to perform the noted functions. Other embodiments of data preparation could be used without departing from the scope of this disclosure.

As illustrated in FIG. 28, the method 2800 begins at step 2810. At step 2810, a UE may transmit, to a BS (e.g., a gNB 101-103 of FIGS. 1 and 2), UE capability information that indicates support for data-aided modulation constellations. The data-aided modulation constellations may support a first transmission mode utilizing data symbols for channel estimation.

At step 2820, the UE may receive, from the BS, a modulation and coding scheme (MCS) indication.

At step 2830, the UE may determine, based on the MCS indication, a first data-aided modulation constellation.

At step 2840, the UE may generate first modulation symbols from input bits according to the first determined data aided modulation constellation. The input bits may be the output of a channel coding block (e.g., the channel encoder 702 of FIG. 7), and thus the input to a modulation block (e.g., the modulator 705 of FIG. 7). The input bits may also include the input bits to the channel coding block.

At step 2850, the UE may transmit, to the BS, the first modulation symbols.

In some embodiments, the UE may further receive, from the BS, data-aided transmission configuration information that indicates a mapping between MCS indices and the data-aided modulation constellations supported by the UE. In those embodiments, the UE may determine, based on the MCS indication, an MCS index. The first data-aided modulation constellation may be determined based on the MCS index and the mapping. That is, the index and the mapping may be utilized to determine that data-aided modulation constellation. The data-aided transmission configuration information may be received separately from the MCS indication. The data-aided transmission configuration information may be conveyed via RRC signaling and the MCS indication may be via a DCI or any other appropriate signaling or information. Thus, the mapping may be conveyed in the data-aided transmission configuration information, and the MCS index may be conveyed in the MCS indication. The data-aided transmission configuration information may include information that maps the MCS indices to entries in an LUT. The entries in the LUT may include one or more of an MCS index, a modulation order, a target code rate, or an index to a corresponding data-aided modulation constellation. The first modulation symbols may be generated from the input bits according to the first data-aided modulation constellation that maps to the determined MCS index. The data-aided transmission configuration information may include one or more of an indicator for enabling data-aided transmission, a list of DMRS patterns for the first transmission mode, a list of modulation constellations, a list of multi-antenna precoders for the first transmission mode, an uplink shared channel indicator, or DMRS frequency-hopping parameters for the first transmission mode.

In some embodiments, the UE may further transmit, to the BS, a recommendation to switch a transmission mode based on local data associated with the UE. The transmission mode may include the first transmission mode or a second transmission mode utilizing reference signals for channel estimation. In these embodiments, the UE may also transmit, to the BS, second modulation symbols. The second modulation symbols may be generated based on an MCS indication for the switched transmission mode. This MCS indication may be transmitted, by the BS, based on the UE's recommendation to switch the transmission mode. The UE may further receive, from the BS, a command to switch a transmission mode. The transmission mode may include the first transmission mode or a second transmission mode using reference signals for channel estimation. In addition, the UE may transmit, to the BS, second modulation symbols. The second modulation symbols may be generated based on an MCS indication for the switched transmission mode.

In some embodiments, the UE may further transmit, to the BS, assistance information for the first transmission mode. In these embodiments, the UE may also receive, from the BS, the MCS indication based on the assistance information. The assistance information may include at least one of: a recommended MCS index for the first transmission mode based on local data associated with the UE and a pre-defined time upon lapse of which the UE is to switch to the first transmission mode from a second transmission mode using reference signals for channel estimation; a recommendation to switch from the first transmission mode to the second transmission mode based on the local data and a pre-defined time upon lapse of which the UE is to switch from the first transmission mode to the second transmission mode; a UE trajectory information; a sensing information associated with the UE; and downlink channel measurements based on received DMRS.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A user equipment (UE) comprising:
a transceiver configured to:
transmit, to a base station (BS), UE capability information that indicates support for data-aided modulation constellations, wherein the data-aided modulation constellations support a first transmission mode utilizing data symbols for channel estimation, and
receive, from the BS, a modulation and coding scheme (MCS) indication; and
a processor operably coupled to the transceiver and configured to:
determine, based on the MCS indication, a first data-aided modulation constellation, and
generate first modulation symbols from input bits according to the first determined data-aided modulation constellation,
wherein the transceiver is further configured to transmit, to the BS, the first modulation symbols.

2. The UE of claim 1, wherein:
the transceiver is further configured to receive, from the BS, data-aided transmission configuration information that indicates a mapping between MCS indices and the data-aided modulation constellations supported by the UE;
the processor is further configured to:
determine, based on the MCS indication, an MCS index; and
the first data-aided modulation constellation is determined based on the MCS index and the mapping.

3. The UE of claim 2, wherein:
the data-aided transmission configuration information comprises information that maps the MCS indices to entries in a lookup table (LUT),
the entries in the LUT include one or more of an MCS index, a modulation order, a target code rate, or an index to a corresponding data-aided modulation constellation, and
the processor is further configured to generate the first modulation symbols from the input bits according to the first data-aided modulation constellation that maps to the determined MCS index.

4. The UE of claim 2, wherein the data-aided transmission configuration information includes one or more of an indicator for enabling data-aided transmission, a list of demodulation reference signal (DMRS) patterns for the first transmission mode, a list of modulation constellations, a list of multi-antenna precoders for the first transmission mode, an uplink shared channel indicator, or DMRS frequency-hopping parameters for the first transmission mode.

5. The UE of claim 1, wherein the transceiver is further configured to:
transmit, to the BS, a recommendation to switch a transmission mode based on local data associated with the UE, the transmission mode comprising the first transmission mode or a second transmission mode utilizing reference signals for channel estimation; and
transmit, to the BS, second modulation symbols, wherein the second modulation symbols are generated based on an MCS indication for the switched transmission mode.

6. The UE of claim 1, wherein the transceiver is further configured to:
receive, from the BS, a command to switch a transmission mode, the transmission mode comprising the first transmission mode or a second transmission mode using reference signals for channel estimation; and
transmit, to the BS, second modulation symbols, wherein the second modulation symbols are generated based on an MCS indication for the switched transmission mode.

7. The UE of claim 1, wherein:
the transceiver is further configured to:
transmit, to the BS, assistance information for the first transmission mode, and
receive, from the BS, the MCS indication based on the assistance information; and
the assistance information comprises at least one of:
a recommended MCS index for the first transmission mode based on local data associated with the UE and a pre-defined time upon lapse of which the UE is to switch to the first transmission mode from a second transmission mode using reference signals for channel estimation;
a recommendation to switch from the first transmission mode to the second transmission mode based on the local data and a pre-defined time upon lapse of which the UE is to switch from the first transmission mode to the second transmission mode;
a UE trajectory information;
a sensing information associated with the UE; and
downlink channel measurements based on received demodulation reference signals (DMRS).

8. A base station (BS) comprising:
a transceiver configured to:
receive, from a user equipment (UE), UE capability information that indicates support for data-aided modulation constellations, wherein the data-aided modulation constellations support a first transmission mode utilizing data symbols for channel estimation;
transmit, to the UE a modulation and coding scheme (MCS) indication; and
receive, from the UE, first modulation symbols generated from input bits according to a first data-aided modulation constellation determined based on the MCS indication.

9. The BS of claim 8, wherein:
the transceiver is further configured to transmit, to the UE, data-aided transmission configuration information that indicates a mapping between MCS indices and the data-aided modulation constellations supported by the UE;
an MCS index is determined, by the UE, based on the MCS indication; and
the first data-aided modulation constellation is determined, by the UE, based on the MCS index and the mapping.

10. The BS of claim 9, wherein:
the data-aided transmission configuration information comprises information that maps the MCS indices to entries in a lookup table (LUT),
the entries in the LUT include one or more of an MCS index, a modulation order, a target code rate, or an index to a corresponding data-aided modulation constellation, and
the first modulation symbols are generated, by the UE, from the input bits according to the first data-aided modulation constellation that maps to the determined MCS index.

11. The BS of claim 8, wherein the transceiver is further configured to:
receive, from the UE, a recommendation to switch a transmission mode based on local data associated with the UE, the transmission mode comprising the first transmission mode or a second transmission mode utilizing reference signals for channel estimation; and
receive, from the UE, second modulation symbols, wherein the second modulation symbols are generated based on an MCS indication for the switched transmission mode.

12. The BS of claim 8, wherein the transceiver is further configured to:
transmit, to the UE, a command to switch a transmission mode, the transmission mode comprising the first transmission mode or a second transmission mode using reference signals for channel estimation; and
receive, from the UE, second modulation symbols, wherein the second modulation symbols are generated based on an MCS indication for the switched transmission mode.

13. The BS of claim 8, wherein:
the transceiver is further configured to:
receive, from the UE, assistance information for the first transmission mode, and
transmit, to the UE, the MCS indication based on the assistance information; and
the assistance information comprises at least one of:
a recommended MCS index for the first transmission mode based on local data associated with the UE and a pre-defined time upon lapse of which the UE is to switch to the first transmission mode from a second transmission mode using reference signals for channel estimation;
a recommendation to switch from the first transmission mode to the second transmission mode based on the local data and a pre-defined time upon lapse of which the UE is to switch from the first transmission mode to the second transmission mode;
a UE trajectory information;
a sensing information associated with the UE; and
downlink channel measurements based on received demodulation reference signals (DMRS).

14. A method performed by a user equipment (UE), the method comprising:
transmitting, to a base station (BS), UE capability information that indicates support for data-aided modulation constellations, wherein the data-aided modulation constellations support a first transmission mode utilizing data symbols for channel estimation,
receiving, from the BS, a modulation and coding scheme (MCS) indication;
determining, based on the MCS indication, a first data-aided modulation constellation;
generating first modulation symbols from input bits according to the first determined data-aided modulation constellation; and
transmitting, to the BS, the first modulation symbols.

15. The method of claim 14, further comprising:
receiving, from the BS, data-aided transmission configuration information that indicates a mapping between MCS indices and the data-aided modulation constellations supported by the UE; and
determining, based on the MCS indication, an MCS index,
wherein the first data-aided modulation constellation is determined based on the MCS index and the mapping.

16. The method of claim 15, wherein:
the data-aided transmission configuration information comprises information that maps the MCS indices to entries in a lookup table (LUT),
the entries in the LUT include one or more of an MCS index, a modulation order, a target code rate, or an index to a corresponding data-aided modulation constellation, and
the first modulation symbols are generated from the input bits according to the first data-aided modulation constellation that maps to the determined MCS index.

17. The method of claim 15, wherein the data-aided transmission configuration information includes one or more of an indicator for enabling data-aided transmission, a list of demodulation reference signal (DMRS) patterns for the first transmission mode, a list of modulation constellations, a list of multi-antenna precoders for the first transmission mode, an uplink shared channel indicator, or DMRS frequency-hopping parameters for the first transmission mode.

18. The method of claim 14, further comprising:
transmitting, to the BS, a recommendation to switch a transmission mode based on local data associated with the UE, the transmission mode comprising the first transmission mode or a second transmission mode utilizing reference signals for channel estimation; and
transmitting, to the BS, second modulation symbols, wherein the second modulation symbols are generated based on an MCS indication for the switched transmission mode.

19. The method of claim 14, further comprising:
receiving, from the BS, a command to switch a transmission mode, the transmission mode comprising the first transmission mode or a second transmission mode using reference signals for channel estimation; and
transmitting, to the BS, second modulation symbols, wherein the second modulation symbols are generated based on an MCS indication for the switched transmission mode.

20. The method of claim 14, further comprising:
transmitting, to the BS, assistance information for the first transmission mode, and
receiving, from the BS, the MCS indication based on the assistance information,
wherein the assistance information comprises at least one of:
a recommended MCS index for the first transmission mode based on local data associated with the UE and a pre-defined time upon lapse of which the UE is to switch to the first transmission mode from a second transmission mode using reference signals for channel estimation;
a recommendation to switch from the first transmission mode to the second transmission mode based on the local data and a pre-defined time upon lapse of which the UE is to switch from the first transmission mode to the second transmission mode;
a UE trajectory information;
a sensing information associated with the UE; and
downlink channel measurements based on received demodulation reference signals (DMRS).
